(19) United States
(12) Patent Application Publication
(10) Pub. No.: US 2007/0027816 A1
(43) Pub. Date: Feb. 1, 2007

(54) METHODS AND SYSTEMS FOR IMPROVED SECURITY FOR FINANCIAL TRANSACTIONS THROUGH A TRUSTED THIRD PARTY ENTITY

(76) Inventor: Shea M. Writer, Wilmington, NC (US)

Correspondence Address: DUFT BORNSEN & FISHMAN, LLP, 1526 SPRUCE STREET, SUITE 302, BOULDER, CO, 80302, US

(21) Appl. No.: 11/460,167

(22) Filed: Jul. 26, 2006

Related U.S. Application Data
(60) Provisional application No. 60/702,955, filed on Jul. 27, 2005.

(51) Int. Cl. G06Q 99/00

(52) U.S. Cl. 705/65

(57) ABSTRACT

Improved systems and methods for financial transactions through a trusted third party entity that improve the security of the transactions. A payment system may build a database of reasonably verified voice prints for verifying a consumer's authorization for a transaction, The method comprises receiving a payment request from a consumer to transfer a valued asset from an account to a seller. The method further comprises receiving from the consumer a vocal authorization for the payment request. The vocal authorization may then be digitized into a voice print and stored in the database with the payment request. In response to receiving the voice authorization, the payment system completes the payment request for the consumer and transfers the valued asset from the account to the seller. The voice print may then be used for verifying the identity of a consumer making a subsequent payment from the account.

### RELATED APPLICATIONS

This non-provisional application claims the benefit of the filing date of provisional application Ser. No. 60/702,955 filed on Jul. 27, 2005, which is herein incorporated by reference,

### BACKGROUND OF THE INVENTION

1. Field of the Invention

The invention relates generally to financial transactions on a network and more specifically relates to improved security for financial transactions through a trusted third party entity.

2. Discussion of Related Art

Use of the Internet has grown at a rapid pace over the years. In particular, there has been tremendous growth in the area of secured financial transactions. Such transactions may include, for example, purchases between two parties, such as a consumer and a seller, as well as single party transactions to deposit or withdraw funds or other valued commodities from a financial institution, such as a bank. A transaction may further comprise a request to manipulate account information, such as first name, last name, change of email address, change of login information, etc. A transaction may also adjust a known identity, with the transaction further requiring a vocal authorization as described below.

When a transaction involves two parties, such as a buyer and a seller, the seller wants to assure that it receives payment and the buyer wants to reduce the number of parties to whom personal financial information may be revealed. To improve the financial transaction for both parties, a number of third parties have emerged to provide independent services as an intermediary between two parties or as a trusted agent to hold funds or commodities on behalf of a client. PayPal, VISANet, Western Union and others are exemplary of such service providers that provide secure financial transaction services to customers (e.g., to buyers, to sellers, and/or to asset owners). These services and service providers are also known as payment systems.

These service providers often require consumers to open an account with the payment system. This typically involves providing personal information, such as a name, an address, an email address, etc. Further, these payment systems often attempt to verify the identity of the new account holder through various means, such as requiring the account holder to provide a credit card or bank account, and then making a deposit or charge to the bank account or credit card. The payment system then asks the bank account user or credit card user, which presumably are the same as the account holder, to verify the amount of the deposit or charge to confirm the identity of the account holder. Since banks verify an account holder's identity, the payment system may reasonably verify the identity of the account holder through this process. One such verification system is described in co-pending U.S. patent application Ser. No. 10/486,026 filed on Feb. 6, 2004 and hereby incorporated herein by reference. Once the account holder's identity is verified, the account holder may then initiate or receive payments through the payment system.

Though these and other service providers provide a number of useful features for secured financial transactions over a network, a number of challenges remain. For example, despite a number of security features to verify an identity of a party to a transaction (e.g., a buyer in a purchase transaction), identity theft and consumer fraud remain problems in such network based transactions. Even if the account holder's identity has been verified successfully, it is still difficult to verify the identity of the buyer initiating the payment request to determine that the buyer is in fact the account holder. For example, it is still easy to make purchases using another person's identity, credit card information, etc. Further, with password protected accounts, passwords may be acquired by unauthorized users through various means, such as phishing techniques which prey on consumer vulnerabilities and ignorance, and are used to make unauthorized transactions.

These payment systems are further plagued by consumer fraud. With many payment systems, a consumer may make a purchase from a seller, and later the consumer may dispute his or her authorization for the transaction. Because the source of funds for many payment systems are credit cards, which are very pro-consumer, the payment systems often must transfer the funds for the purchase back to the consumer, even though the funds may have already been transferred by the payment system to the seller or another party. With network based transactions, it is often difficult for the seller or the payment system to counter the consumer's claim that the purchase was not authorized. As such, the seller and/or payment system takes a financial loss on the transaction.

A further problem with payment systems arises when financial transactions involve multiple national currencies. The conversion between multiple currencies may cause problems for one or both parties to the transaction as well as for the trusted payment system. One or both parties exchanging value may be underpaid or overcharged due to currency conversion issues and timing of the conversion by the trusted third party service provider or payment system.

A still further problem exists when transactions involve a third party processor, such as a credit card company or a bank. Many times credit card companies mandate that certain transactions be “coded” to categorize and describe the nature of the transaction. Credit card companies will force specifically “coded” transactions on an entire payment network should even one of the system's transactions meet a certain specification. The result is that all transactions on the payment network are then incorrectly denoted as defined by the singular transaction. This may result in higher transaction costs for the payment system than if transactions were “coded” a different type.

Further, credit card companies consider a transaction transferring funds to the payment system as a cash advance, rather than as a completed purchase. This allows the credit card company to legally claim jurisdiction for a second transaction between the buyer and the seller, as the credit card company has an “arms length” interest in the transaction. As such, the credit card company or third party processor works to protect their interest, which is often at odds with the interest of the payment system and/or seller.

In view of the above discussion, it is evident that an ongoing need exists for improved usability and security in network based secured financial transactions.

### SUMMARY OF THE INVENTION

The present invention improves upon prior systems and methods for secured network based financial transactions by providing methods and systems for network based secured financial transactions that improve the security of the transactions, shift the burden of risk for the transactions, and improve flexibility for international transactions.

In one aspect hereof, a payment system may build a database of reasonably verified voice prints for verifying a consumer's authorization for a transaction. The method comprises receiving a payment request from a consumer to transfer a valued asset from a consumer's account to a seller. The method further comprises receiving from the consumer a vocal authorization for the payment request. The vocal authorization may then be digitized into a voice print and stored in the database with the payment request. In response to receiving the voice authorization, the payment system completes the payment request for the consumer and transfers the valued asset from the account to the seller. The voice print may then be used for verifying the identity of a consumer making a subsequent payment from the account.

Another aspect of the invention comprises a trusted third party transfers between other parties credits that are secured by a globally valued commodity such as gold or other precious metals. The transfer of such commodity values represents an asset recognized by virtually all sovereigns as globally valued.

Another aspect of the invention comprises a method for communicating with a payment system using a reverse firewall. The reverse firewall monitors outgoing communications for sensitive information. The method comprises requiring the consumer to download a plugin module to a client application. Login information, such as a personal identification number, a username, a password, etc. for the consumer is allocated and provided by the payment system to the client application. The login information is used in subsequent communications between the client application and the payment system. The plugin module monitors a port used by the client application for communications from the client application using the login information. The plugin module determines if a communication from the client application using the login information is directed to an authenticated server of the payment system. The plugin module further stops the communication from the client application using the login information if the communication is directed to a non-authenticated server.

Another aspect of the invention comprises a payment system providing credibility ratings for a seller collected from a plurality of consumers completing transactions with the seller. The credibility rating may then be provided to prospective consumers to determine whether to complete a transaction with the seller. The method comprises receiving a payment request in the payment system from a consumer directed to the seller. The payment system further completes the payment request, and receives a transaction rating from the consumer regarding the seller, In response to receiving the transaction rating from the consumer, the payment system issues an account rebate to the consumer. The transaction rating may then be integrated in a credibility rating of the seller and provided to prospective consumers or other parties.

In another aspect hereof, a method of operating a payment system is provided. The method comprises requiring a consumer to establish an account. The method further comprises allowing the consumer to initiate a transaction using a third party processor to transfer funds into the account. The method further comprises receiving from the consumer a vocal authorization for the transaction, The method further comprises digitizing the vocal authorization into a voice print and storing the voice print in association with the transaction.

The invention may include other exemplary embodiments described below.

### DESCRIPTION OF THE DRAWINGS

The same reference number represents the same element on all drawings.

FIG. 1 is a flow chart illustrating a method of building a database of reasonably verified voice prints in a payment system in an exemplary embodiment of the invention.

FIG. 2 is a flow chart illustrating a method for communicating with a payment system using a reverse firewall in an exemplary embodiment of the invention.

FIG. 3 is a flow chart illustrating a method for determining a credibility rating of a seller in a payment system in an exemplary embodiment of the invention.

FIG. 4 is a flow chart illustrating a method for determining a credibility rating of a seller in a payment system in an exemplary embodiment of the invention.

FIG. 5 is a flow chart illustrating a method for communicating with a payment system using a reverse firewall in an exemplary embodiment of the invention.

FIG. 6 is a flow chart illustrating a method for communicating with a payment system for micro payments in an exemplary embodiment of the invention.

FIG. 7 is a flow chart illustrating a method for creating a reliability rating for a voice print in an exemplary embodiment of the invention.

FIG. 8 is a flow chart illustrating a method for determining the trustworthiness or reliability rating of a voice print in an exemplary embodiment of the invention.

FIG. 9 is a flow chart illustrating a method for approving a subsequent transaction based on a voice print in an exemplary embodiment of the invention.

FIG. 10 is a flow chart illustrating a method for digitizing the vocal authorization into a voice print in an exemplary embodiment of the invention.

FIG. 11 is a flow chart illustrating a method of operating a payment system in an exemplary embodiment of the invention,

FIG. 12 is a flow chart illustrating a method for transferring funds in an exemplary embodiment of the invention.

FIG. 13 is a payment system for building a database of reasonably verified voice prints in a payment system in an exemplary embodiment of the invention.

### DETAILED DESCRIPTION OF THE INVENTION

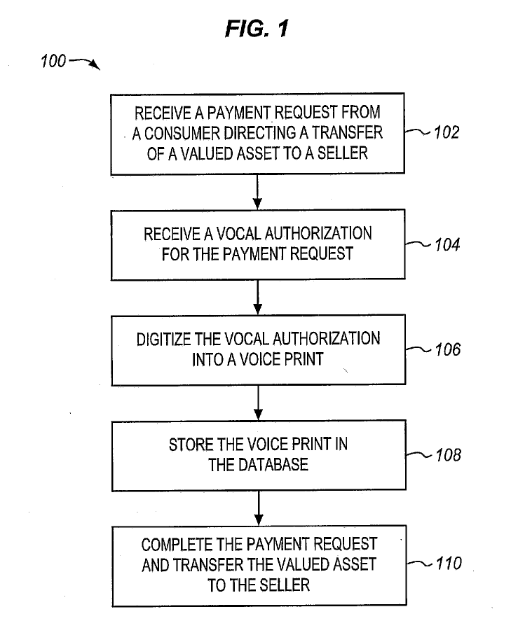

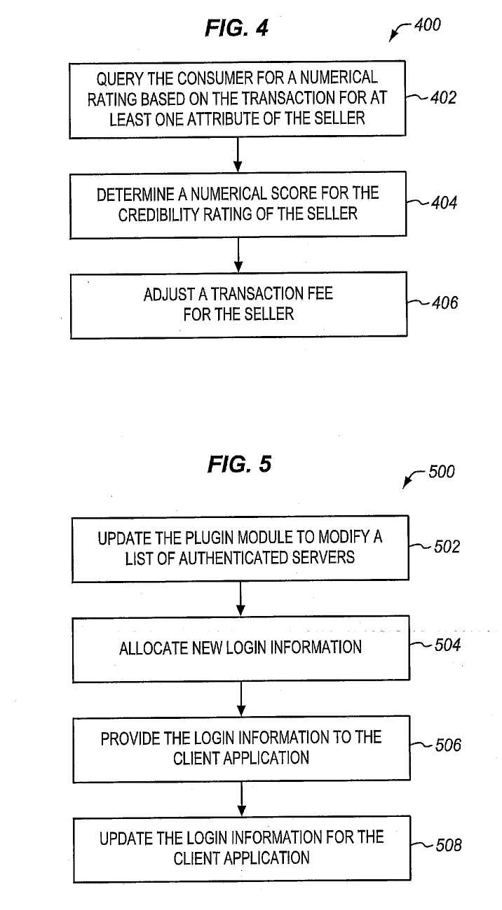

FIG. 1-13 and the following description depict specific exemplary embodiments of the invention to teach those skilled in art how to male and use the invention. For the purpose of teaching inventive principles, some conventional aspects of the invention have been simplified or omitted. Those skilled in the art will appreciate variations from these embodiments that fall within the scope of the invention. Those skilled in the art will appreciate that the features described below can be combined in various ways to form multiple variations of the invention. As a result, the invention is not limited to the specific embodiments described below, but only by the claims and their equivalents.

As used herein, a payment system is any system or network by which a consumer or a user may subscribe to the network and deposit initial funds in his or her account. For example, a payment system may require a consumer to register for an account by submitting his or her basic personal information, such as first name, last name, email address, etc. through a web site, WAP, fax, phone, etc. The initial deposit in the account may come for example from a credit card or a transfer of funds from a bank account to the consumer's account in the payment system. Further, the initial funding of the account may occur prior to the consumer initiating a payment request to a seller, may occur simultaneously to the payment request, or may occur subsequent to the initiation of the payment request.

As used herein, a consumer is a party initiating a payment in the payment system directed to a second party (“a seller”). As used herein, a seller is a party receiving a payment in the payment system from a party (“a consumer”). The typical transaction on a payment system involves another party (“consumer”) making a purchase from a merchant or another party (“seller”). However, those skilled in the art will recognize other transactions on a payment system not involving a buyer/seller relationship between the parties.

FIG. 1 is a flow chart illustrating a method 100 of building a database of reasonably verified voice prints in a payment system in an exemplary embodiment of the invention. The steps of method 100 are not all inclusive and may include other steps not shown.

In step 102, a payment request is received by the payment system from a consumer directing a transfer of a valued asset to a seller. The valued asset for example may be a particular recognized currency of a country, a stored value commodity such as gold, other precious metals, a sovereign entity, a type of property, etc. A sovereign entity is an asset not regulated and backed by a sovereign nation, such as the United States.

Further, the valued asset may be currency credits, wherein the currency credits have specified values relating to a particular currency. For example, a consumer in the United States may purchase currency credits using US dollars. The currency credits may have a value of X US Dollars, and Y British Pounds. The values of X and Y may be set by the payment system to minimize wide fluctuations caused by normal currency conversions between differing currencies. At a later date, the consumer may choose to make a payment to a seller in Great Britain, and the seller may display a price in currency credits so the consumer does not need to worry about a currency conversion.

In step 104, the payment system receives a vocal authorization for the payment request. For example, the payment system may direct the consumer to call a telephone number and state his or her express authorization for the transaction. In a web based system, the call may be directed through a VOIP system or other communication network connected to the payment system.

In step 106, the payment system may digitize the vocal authorization into a voice print. The digitization may involve saving the recording of the vocal authorization into an audio file.

In step 108, the payment system stores the voice print in the database in association with the transaction. For example, the voice print file may be saved with the corresponding transaction number.

In step 110, the payment system completes the payment request and transfers the valued asset to the seller.

Once the voice print is captured, the payment system may use the voice print for improving identity management and reducing financial transaction fraud. At the simplest level, the process of requiring the voice print instills initially a minimal psychological commitment in the mind of the account holder. The voice print may then be accessed for playback by the account holder at a later time. For example, a web based payment system may display a link to the corresponding vocal authorization so that the account holder is reminded of his or her verbal commitment. The voice print may be additionally used to provide proof to a third party processor, such as a credit card company that the consumer authorized the transaction.

Further, the voice print may be used to compare with voice prints of vocal authorizations for subsequent transactions to determine if the consumer is in fact the account holder. The payment system may use a reliability rating to determine a probability that the voice print is authentic for an account holder of the account and that the consumer is the account holder. The reliability rating may be defined and adjusted based on various heuristic factors, such as time, frequency of transactions, value of transactions, types of transactions, purchasing history, etc. As the reliability rating rises, the payment system may reasonably determine that the voice print is authentic for the account holder, and may make adjustments to the account, such as allowing the account holder to transfer larger values of funds or valued assets.

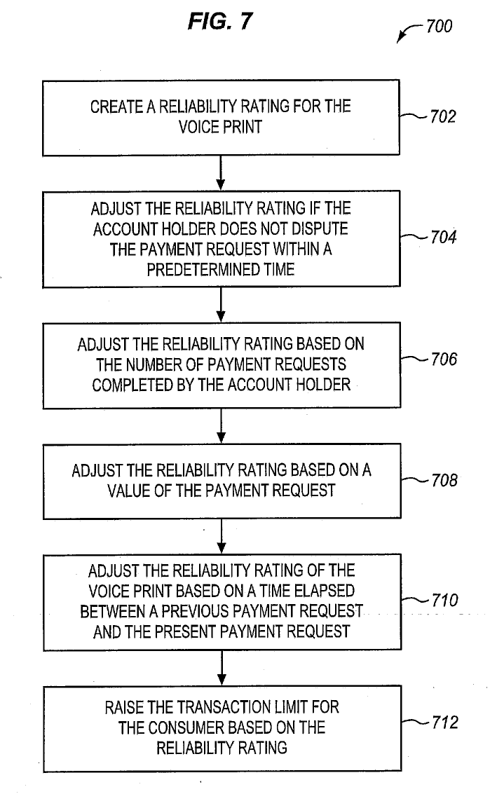

FIG. 7 is a flow chart illustrating a method 700 for creating a reliability rating for a voice print in an exemplary embodiment of the invention. The steps of method 700 are not all inclusive and may include other steps not shown.

In step 702, the payment system creates a reliability rating for the voice print. The reliability rating comprises a score representing a probability that the voice print is authentic for an account holder of the account and that the consumer is the account holder.

In step 704, the reliability rating may be adjusted if the account holder does not dispute the payment request within a predetermined time. Many payment systems allow a consumer to dispute a transaction within a predetermined time (i.e. a grace period). For example, if the grace period is 90 days, and the account holder has not disputed the transaction after the grace period expires, then the payment system may determine with reasonably certainty that the transaction was authorized by the account holder, and that the consumer voice print captured represents the account holder. Otherwise, if the transaction was unauthorized, the account holder most likely would have disputed the transaction. Thus, the payment system may raise the reliability rating of the voice print to capture the reasonable certainty that the voice print represents the account holder.

In step 706, the reliability rating may be adjusted based on the number of payment requests completed by the account holder. For example, if the account holder completes a high number of transactions without dispute, then the payment system may determine with reasonably certainty that the transactions were authorized by the account holder, and that the consumer voice print captured represents the account holder. Thus, the payment system may raise the reliability rating of the voice print to capture the reasonable certainty that the voice print represents the account holder.

In step 708, the reliability rating may be adjusted based on a value of the payment request. For example, if the payment request represents a very high value and the account holder does not dispute the transaction, then the payment system may determine with reasonable certainty that the transaction was authorized by the account holder, and that the consumer voice print captured represents the account holder. Thus, the payment system may raise the reliability rating of the voice print to capture the reasonable certainty that the voice print represents the account holder.

In step 710, the reliability rating may be adjusted based on a time elapsed between a previous payment request and the present payment request. Statistical analysis may show that as the amount of time from the account holder's last transaction increases, it may be more likely that a transaction is unauthorized. Thus, the account holder shall be increasingly categorized as “distrusted”. The converse would suggest a more “trusted” account.

By contrast, statistical analysis may show that as the amount of time from the account holder's last transaction increases, it may be more likely that a transaction is authorized. Thus, the account holder shall be increasingly categorized as “trusted”. The converse would suggest a more “distrusted” account.

In step 712, the payment system may raise the transaction limit for the consumer based on the reliability rating. For example, the payment system may have an initial transaction limit for new accounts, and once the reliability rating reaches a predefined threshold, the transaction limit may be raised to a higher dollar amount.

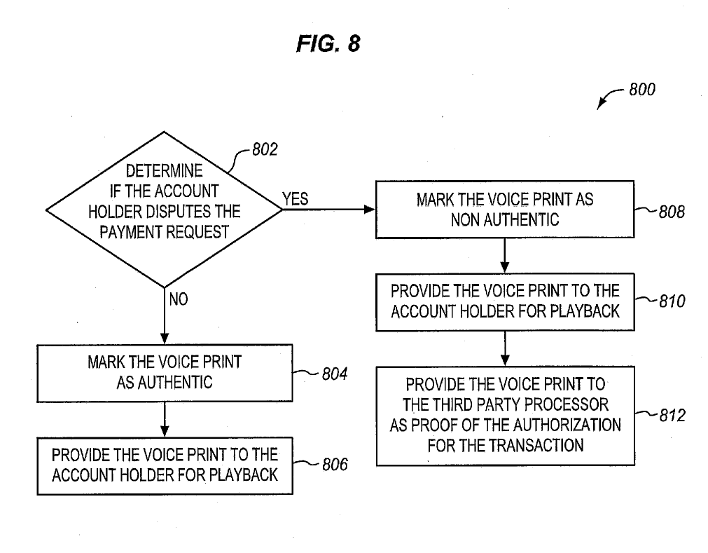

A voice print may alternatively be marked as trusted or distrusted, depending on whether the payment request is disputed by the account holder. FIG. 8 is a flow chart illustrating a method 800 for determining the trustworthiness or reliability rating of a voice print in an exemplary embodiment of the invention. The steps of method 800 are not all inclusive and may include other steps not shown.

In step 802, the payment system determines if the account holder has disputed the payment request. For example, the determining step may occur subsequent to the expiration of a grace period for disputing a transaction.

If the payment request has not been disputed, then the payment system may mark the voice print as authentic in step 804. If the payment request has been disputed, then the payment system may mark the voice print as non-authentic in step 808.

In the event of a payment dispute, the voice print may be further provided to the account holder for playback in step 810. For example, an account holder may forget about a transaction, and the voice print playback will remind the account holder, who may decide to cancel the dispute. If the account holder was not captured in the voice print, then the account holder may be able to identify the non-authorized party on the voice print for criminal prosecution, etc. Alternatively, the voice print may still be provided to the account holder in step 806 even if the payment request has not been disputed.

In the case of an unresolved dispute, the voice print may be provided to a third party processor, such as a credit card company, in step 812 as proof that the transaction was authorized by the account holder. The third party processor may then use the voice print to determine whether to reverse the transaction and return the funds to the account holder, or to deny the dispute and allow the payment system and/or the seller to retain the funds.

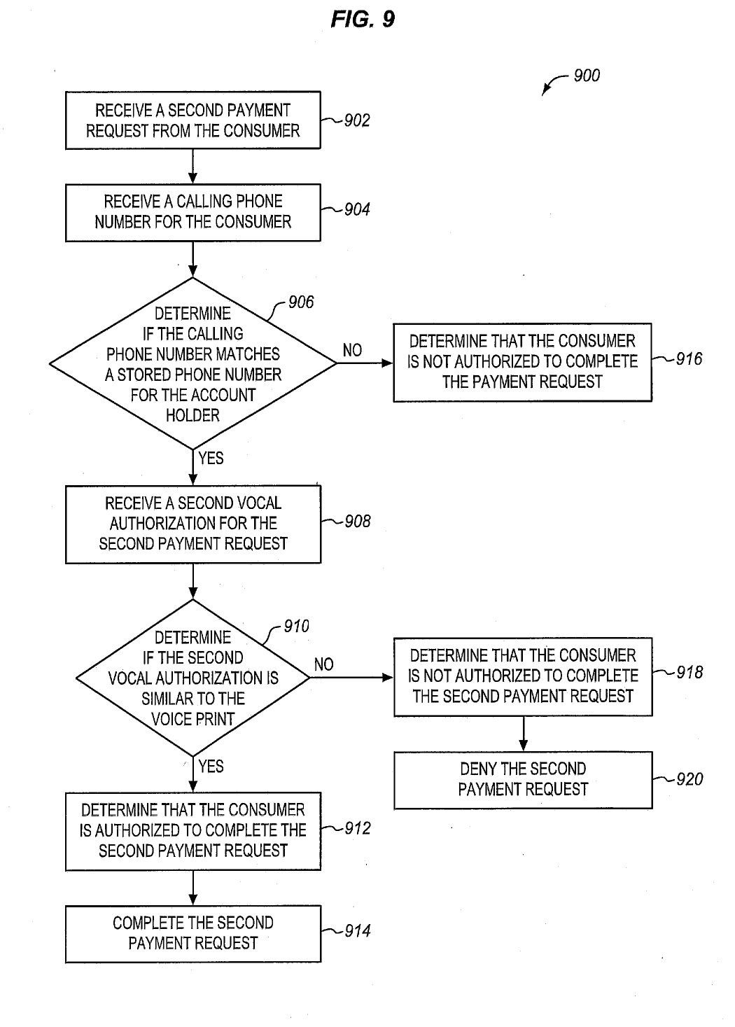

A “trusted” or authentic voice print may be used to approve or reject a subsequent transaction based on the established reliability rating associated with the voice print, as well as comparing a second captured vocal authorization for the subsequent transaction with the previously captured voice print. Voice authentication techniques allow two voice samples to be compared to determine a probability that the voice samples were both spoken by the same individual. FIG. 9 is a flow chart illustrating a method 900 for approving a subsequent transaction based on a voice print in an exemplary embodiment of the invention. The steps of method 900 are not all-inclusive and may include other steps not shown.

In step 902, the payment system receives a second payment request from the consumer. The payment request process may require the consumer to provide a voice authorization. For example, the consumer may be required to call a telephone number to provide the voice authorization.

In step 904, the payment system determines a calling phone number for the consumer. For example, the calling phone number may be determined by the payment system from a caller ID.

In step 906, the payment system determines if the calling phone number matches a stored phone number for the account holder. For example, the stored phone number may be provided by the account holder upon registration with the payment system, and the payment system may require all vocal authorizations to come from the stored phone number registered for the account.

If the calling phone number does not match the stored phone number, then the payment system may determine that the consumer is not authorized to complete the payment request in step 916, and deny the payment request.

If the calling phone number matches the stored phone number, then the payment system may receive a vocal authorization for the second payment request from the consumer in step 908.

In step 910, the payment system determines if the second vocal authorization is similar to the voice print using voice authentication techniques. Voice authentication captures a person's voice, such as the physical characteristics of the vocal tract and its harmonic and resonant frequencies, and compares it to a stored voice print created previously, such as during the registration process or during a previous transaction.

If the second vocal authorization is not similar to the voice print, then the payment system may determine that the consumer is not authorized to complete the second payment request in step 918, and may deny the second payment request in step 920.

If the second vocal authorization is similar to the voice print, then the payment system may determine that the consumer is authorized to complete the second payment request in step 912, and may complete the second payment request in step 914. Since two voice samples spoken by an individual will never be identical, the payment system may determine that the voice print and the second vocal authorization are identical and that the second vocal authorization is a recording. If the voice print is a recording, then the payment system may determine that the consumer is not authorized to complete the second payment request.

Alternatively, if the payment system holds a non-authentic voice print for an account, then the second vocal authorization may be compared with the non-authentic voice print to determine if the second vocal authorization is not authentic. Using voice authentication techniques, if the non-authentic voice print and the second vocal authorization are the same or similar, then the payment system may determine that the second vocal authorization is non-authentic as well, and deny the payment request.

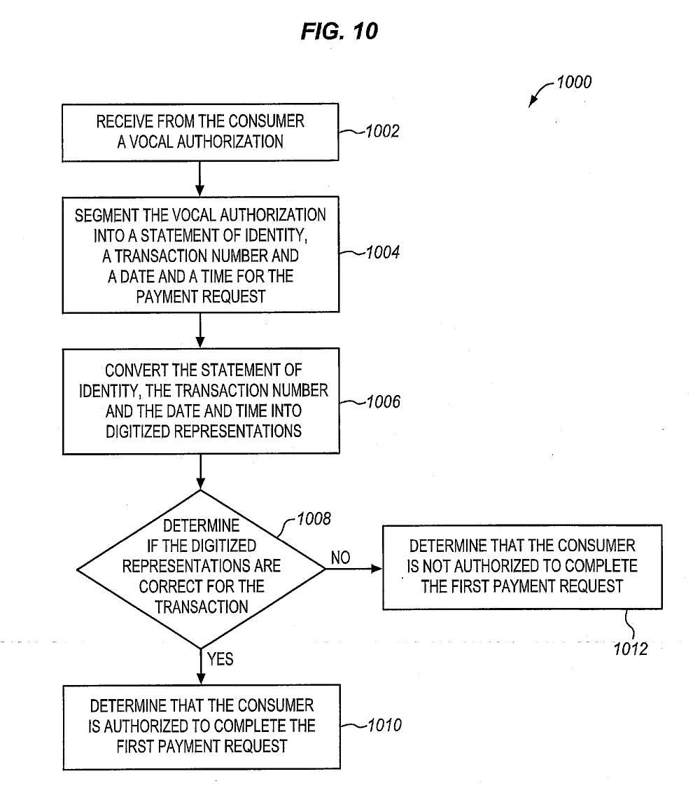

By requiring and verifying dynamic information in a vocal authorization, such as a transaction number or a date and time, the payment system may minimize or eliminate a non-authorized consumer from using a voice recording of the account holder to complete the transaction. FIG. 10 is a flow chart illustrating a method 1000 for digitizing the vocal authorization into a voice print in an exemplary embodiment of the invention. FIG. 10 further illustrates step 106 of method 100. The steps of method 1000 are not all inclusive and may include other steps not shown.

In step 1002, the payment system segments the vocal authorization into a statement of identity (e.g., “My name is Jane Doe”), a transaction number or authorization segment (e.g. “I authorize transaction number 123456”) and a date and a time for the payment request (e.g. “on Jan. 1, 2006 at 12:00 A.M.”).

Using voice recognition techniques, the payment system converts the statement of identity, the transaction number and the date and time into digitized representations in step 1004.

In step 1006, the payment system determines if the digitized representations are correct for the transaction. For example, the payment system may determine if the statement of identity matches the account holder's name. The payment system may further determine if the transaction number is correct for the transaction number. A transaction number will be unique for each transaction. Further, the payment system may determine if the date and the time spoken by the consumer are correct. For different time zones, the payment system may compare the spoken date and time with the time zone of the account holder's registered address.

If the digitized representations are correct, then the payment system may reasonably determine that the voice authorization is not a previously recorded copy of the account holder, and may determine that the consumer is authorized to complete the first payment request in step 1008.

If the digitized representations are not correct, then the payment system may reasonably determine that the voice authorization is a previously recorded copy of the account holder or that the consumer does not know the correct information, and may determine that the consumer is not authorized to complete the first payment request in step 1010.

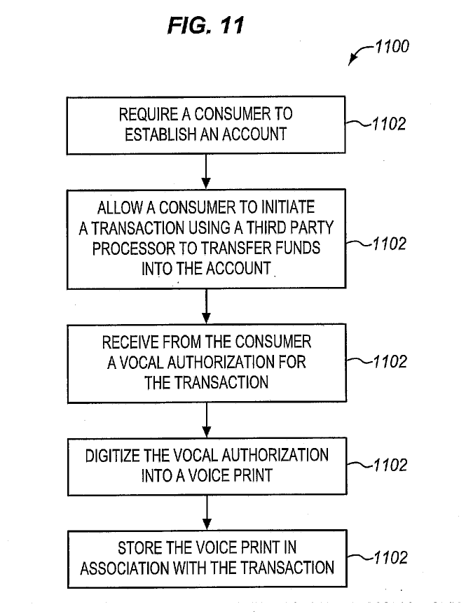

FIG. 11 is a flow chart illustrating a method 1100 of operating a payment system in an exemplary embodiment of the invention. The steps of method 1100 are not all inclusive, and may include other steps not shown.

In step 1102, a consumer is required to establish an account. This may include the consumer providing personal information, such as a name, an address, an email address, etc.

In step 1104, a consumer is allowed to initiate a transaction using a third party processor to transfer funds into the account. For example, the consumer may use a credit card to purchase a set amount of currency credits or gold in the payment system.

In step 1106, the payment system receives from the consumer a vocal authorization for the transaction. The vocal authorization may be similar to the vocal authorization described in method 100. The vocal authorization for example may authorize the payment system to charge an amount to the consumer's credit card.

In step 1108, the payment system digitizes the vocal authorization into a voice print. The digitizing process is as described in method 100.

In step 1110, the voice print is stored in association with the transaction. For example, a payment system web site may show an initial transaction funding the account with a credit card, and a link may point to an audio file of the voice print. Using the techniques from method 800, the voice print may be determined authentic and be used to verify subsequent transactions in the payment system.

Criminals may use various techniques to obtain a username, a password or a PIN number for an account holder's account on the payment system. One of the most common techniques for obtaining this information is through phishing emails, wherein an account holder receives an authentic looking email from the payment system directing the account holder to login to a web site. Usually, these phishing emails warn the account holder that there is a problem with his or her account that needs to be remedied immediately. The link directs the account holder to a web page that may look like the payment system web site, but is not part of the payment system. When the account holder attempts to login to the non-authentic server, the account holder inadvertently provides his or her username and or password to a criminal, who now has access to the account holder's account, and may use the access to complete unauthorized transactions from the account holder's account.

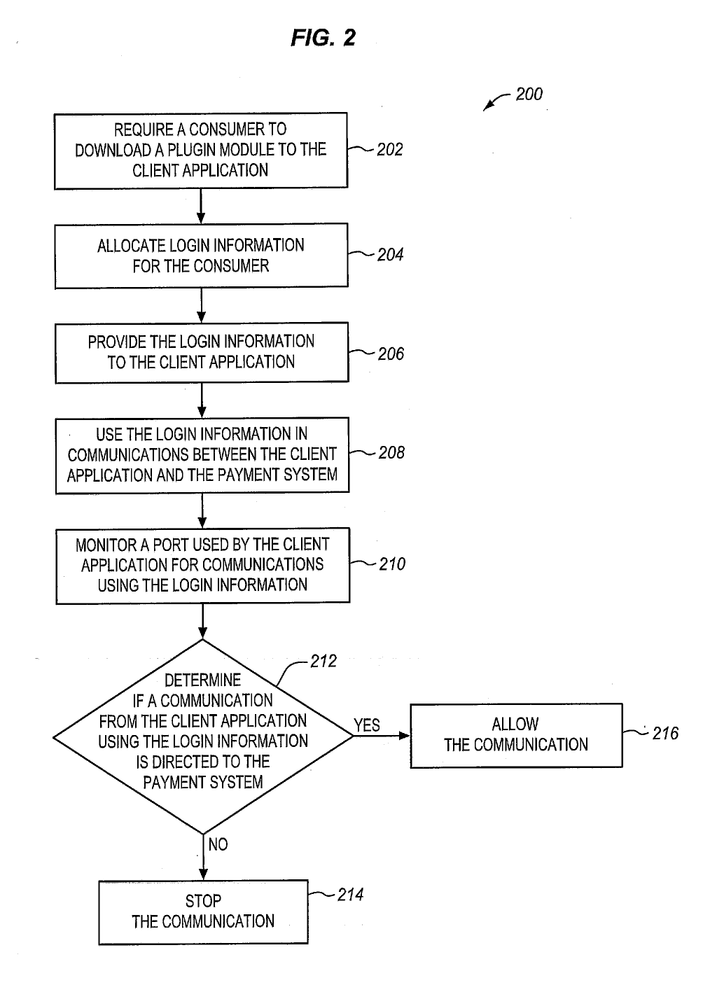

FIG. 2 is a flow chart illustrating a method 200 for communicating with a payment system using a reverse firewall in an exemplary embodiment of the invention, The steps of method 200 are not all inclusive, and may include other steps not shown. The reverse firewall works to stop an account holder from providing his or her personal identification to these non-authentic sites, minimizing or eliminating identity theft and other criminal activities.

In step 202, a consumer is required to download a plugin module to a client application. The client application for example may be a web browser installed on a home computer. The plugin module comprises a reverse firewall for the client application. The plugin module may also be a system tray application installed on the consumer's computer.

In step 204, the payment system allocates login information, such as a personal identification number (PIN), email address, username, password, etc. for the consumer. The client application uses the login information in communications with the payment system to identify and authenticate the consumer to the payment system. The payment system may allocate the login information to the client application upon registration, upon download of the plugin module, upon login, etc.

In step 206, the payment system provides the login information to the client application. For example, the login information may be provided upon download of the plugin module, it may be provided the first time the client application connects with the payment system, etc. Alternatively, a new login information number may be allocated each time the consumer logs into the payment system.

In step 208, the login information is used in communications between the client application and the payment system. For example, the consumer may initiate a payment request to a seller in the payment system through a web site accessed through the client application. The login information may be provided by the client application to the payment system for authentication of the consumer.

In step 210, the plugin module monitors a port used by the client application for communications using the login information. The reverse firewall is a “sniffer” for detecting communications from the client application comprising the login information number.

In step 212, the plugin module determines if a communication from the client application using the login information is directed to the payment system. For example, the plugin module may have a list of authenticated servers of the payment system with associated domain names or IP addresses.

If a communication using the login information is directed at an authenticated server, then the communication is allowed in step 216. Otherwise, if a communication is directed at a non-authenticated server, then the communication is stopped in step 214. For example, the communication may be held or buffered and the user may be presented with a “Warning”, with an option to continue and/or allow the communication under unusual circumstances.

The plugin module may be further updated to provide additional security measures. Such updates may include updating the login information, updating the reverse firewall, updating the list of authenticated servers, etc. FIG. 5 is a flow chart illustrating a method 500 for communicating with a payment system using a reverse firewall in an exemplary embodiment of the invention. The steps of method 500 are not all inclusive, and may include other steps not shown.

In step 502, the payment system updates the plugin module to modify a list of authenticated servers. In step 504, the payment system allocates new login information for the account holder. In step 506, the new login information is provided to the client application. In step 508, the plugin module updates the login information for the client application.

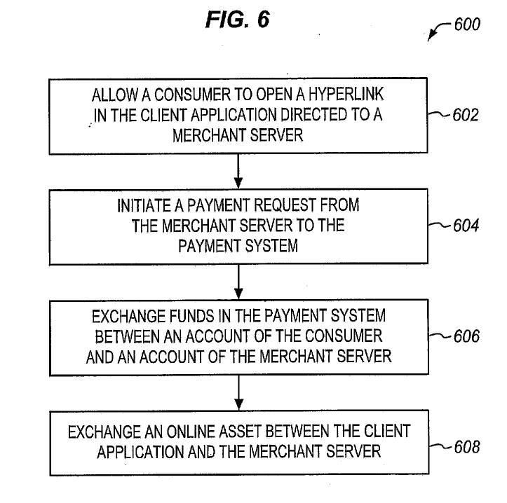

The plugin module may be further utilized to allow the payment system to process micro payments for the account holder. A micro payment is a payment with a value of less than $2.00. FIG. 6 is a flow chart illustrating a method 600 for communicating with a payment system for micro payments in an exemplary embodiment of the invention. The steps of method 600 are not all inclusive, and may include other steps not shown.

In step 602, a consumer is allowed to open a hyperlink in the client application directed to a merchant server. The hyperlink may include a description of an online asset and provide a price of the asset to the consumer. Each hyperlink that the merchant desires to charge a monetary value for may be tagged by the merchant with a value designator. The consumer may be required to login to the payment system prior to or subsequent to opening the hyperlink.

In step 604, a payment request is initiated from the merchant server to the payment system in response to the opening of the hyperlink. The consumer may be tracked through the client plugin, and identifying information of the consumer is passed to the merchant server. The merchant server uses the identifying information to initiate the payment request to the payment system.

In step 606, the payment system exchanges funds between an account of the consumer and an account of the merchant server.

In step 608, an online asset is exchanged between the client application and the merchant server. An online asset is a web page or other digital file offered for purchase by a merchant to a consumer. A server-side micro payment module may rewrite or translate each web page or online asset before serving it for public viewing. Translation may include adding a menubar. The menubar may serve to clearly illustrate to the consumer all micro payment activities as it relates to the crediting or debiting of the consumer's balance and any other information as it relates to illustrating to the consumer the micro-debiting process as each online asset is purchased.

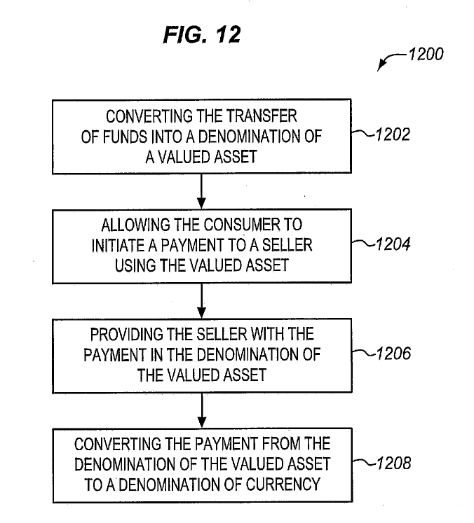

The exchange of funds between an account of the consumer and an account of the merchant server may be in a valued asset, such as gold. The payment system allows the consumer to purchase a valued asset using currency, make a payment in the valued asset to a seller, and allow the seller to convert the valued asset into currency and withdraw the payment. FIG. 12 is a flow chart illustrating a method 1200 for transferring funds in an exemplary embodiment of the invention. The steps of method 1200 are not all inclusive, and may include other steps not shown.

In step 1202, the payment system converts the transfer of funds into a denomination of a valued asset. For example, if the valued asset is gold, then the consumer may purchase X ounces of gold at $Y/ounce. The consumer may then make purchases valued in ounces of gold.

In step 1204, a consumer is allowed to initiate a payment to a seller using the valued asset. For example, the valued asset may be gold valued at worth $10/ounce. If the purchase were for $50, then the consumer would initiate a payment for 5 ounces of gold.

In step 1206, the seller is provided with the payment in the denomination of the valued asset. In the previous example, the seller would receive 5 ounces of gold.

In step 1208, the seller may convert the payment from the denomination of the valued asset to a denomination of currency. In the previous example, the seller may sell the 5 ounces of gold for $10/ounce and receive $50 for the payment.

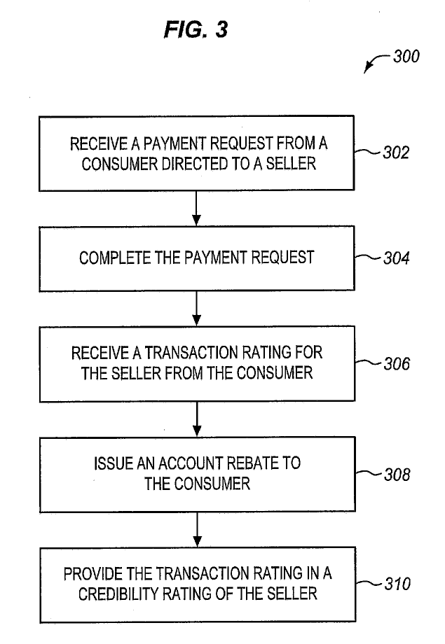

When making purchases over the internet, consumers are often reluctant to purchase from unknown sellers, However, a credibility rating for a business, seller or proprietor built up over time may alleviate some concerns of a consumer. For example, a seller with 100 or 1000 successful transactions may appear very credible to a consumer, who may be more willing to complete a purchase from the seller if the transaction history is made available. FIG. 3 is a flow chart illustrating a method 300 for determining a credibility rating of a seller in a payment system in an exemplary embodiment of the invention. The steps of method 300 are not all inclusive, and may include other steps not shown.

In step 302, the payment system receives a request from a consumer directed to a seller. In step 304, the payment system completes the payment request. The payment request may involve transferring funds from the account of the consumer to the account of the seller.

In step 306, the payment system receives a transaction rating for the seller from the consumer. For example, the payment system may provide a web page for the consumer, or may query the consumer for the transaction rating in an email. The transaction rating may be simply a satisfied or dissatisfied rating, or may involve a series of questions rating various aspects of the transaction.

In step 308, the payment system issues an account rebate to the consumer in response to receiving the transaction rating. The account rebate is an incentive for the consumer to complete the transaction rating.

In step 310, the transaction rating is provided in a credibility rating of the seller to prospective consumers or other parties. For example, the payment system may provide a transaction history for the seller comprising a credibility rating computed from the transaction ratings provided by the consumers in the transaction history. Further, the transaction history may comprise the individual transaction ratings for each transaction. From the credibility rating, a prospective consumer may decide whether or not to make a purchase from the seller.

The credibility rating may be computed as an average or a total of the transaction ratings provided by a plurality of consumers for a plurality of transactions. For example, a seller may receive one point for each positive transaction, and one point for each negative transaction. The credibility rating may be a sum of the points. Alternatively, the credibility rating may be an average of a plurality of ratings from different consumers, FIG, 4 is a flow chart illustrating a method 400 for determining a credibility rating of a seller in a payment system in an exemplary embodiment of the invention. The steps of method 400 are not all inclusive, and may include other steps not shown.

In step 402, the payment system queries the consumer for a numerical rating based on the transaction for at least one attribute of the seller. Exemplary attributes may include customer support, packing an item, condition of an item, speed of shipping, etc. For example, the query may provide the consumer with a form asking the consumer to rate each attribute on a scale of 1-5.

In step 404, the payment system determines a numerical score for the credibility rating of the seller. For instance, each attribute of the credibility rating may be computed based on a numerical score from the plurality of consumers providing a transaction rating. For example, if the attribute rating is for customer service on a scale of 1-5, and five consumers rated the seller 3, 4, 4, 2 and 5 respectively, then the credibility rating for the seller would be a 3.6.

In step 406, the payment system may adjust the transaction fee for the seller based on the credibility rating. For instance, if a seller has a history of disputes or problems with consumers, then the payment system may raise the transaction fee to cover the additional costs imposed by the seller on the payment system. By contrast the transaction fee may be lowered for sellers exhibiting a low problem history with consumers, reflecting the lower costs imposed by the seller on the payment system.

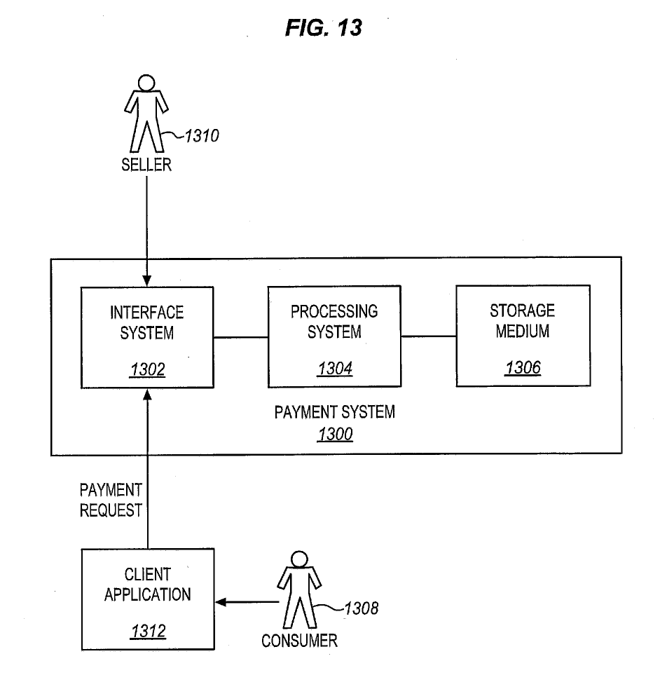

FIG. 13 is a payment system 1300 for building a database of reasonably verified voice prints in a payment system in an exemplary embodiment of the invention. Payment system 1300 comprises an interface system 1302 adapted to receive a first payment request from a consumer 1308 to transfer a valued asset from an account to a seller 1310. The interface system 1302 is further adapted to receive from the consumer 1308 a first vocal authorization for the first payment request. A processing system 1304 coupled to the interface system 1302 is adapted to digitize the first vocal authorization into a voice print, and complete the first payment request for the consumer 1308 and transfer the valued asset from the account to the seller 1310. A storage medium 1306 coupled to the processing system 1304 is adapted to store the voice print in the database in association with the first payment request.

Payment system 1300 may be a single server, a distributed server network, or be coupled to a communication network. Payment system 1300 may further comprise a client application 1312 communicatively coupled with the interface system 1302, and adapted to receive login information from the interface system 1302. Client application 1312 is further adapted to use the login information in subsequent communications with the interface system 1302. Client application 1302 is further adapted to monitor a port used by the client application for communications using the login information, and further adapted to stop a communication using the login information if the communication is not directed to the interface system. Payment system 1300 may require the consumer 1308 to install client application 1312 on a personal computer or other communication device for accessing the payment system 1300.

Although specific embodiments were described herein, the scope of the invention is not limited to those specific embodiments. The scope of the invention is defined by the following claims and any equivalents thereof.

I claim:

1. A method of operating a payment system, the method comprising:
requiring a consumer to establish an account;
allowing the consumer to initiate a transaction using a third party processor to transfer funds into the account;
receiving from the consumer a vocal authorization for the transaction;
digitizing the vocal authorization into a voice print; and
storing the voice print with the transaction.

2. The method of claim 1 further comprising providing the voice print to the consumer for playback.

3. The method of claim 1 further comprising providing the voice print to the third party processor in response to a dispute of the transaction by the consumer to provide proof that the transaction was authorized by the consumer.

4. The method of claim 1 further comprising marking the voice print as authentic if the consumer does not dispute the transaction.

5. The method of claim 1 further comprising marking the voice print as not authentic if the consumer disputes the transaction.

6. The method of claim 1 wherein the allowing step further comprises:
converting the transfer of funds into a denomination of a valued asset, and
allowing the consumer to initiate a payment to a seller using the valued asset.

7. The method of claim 6 further comprising:
providing the seller with the payment in the denomination of the valued asset; and
converting the payment from the denomination of the valued asset to a denomination of currency.

8. The method of claim 6 wherein the valued asset is a sovereign entity.

9. The method of claim 8 wherein the sovereign entity is gold.

10. The method of claim 6 wherein the valued asset is a currency credit.

11. The method of claim 1 further comprising:
converting the transfer of funds into a lease of a commodity; and
allowing the consumer to initiate a purchase using a denomination of the commodity.

12. The method of claim 1 further comprising:
requiring the consumer to download a plugin module to a client application;
allocating login information for the consumer;
providing the login information to the client application;
using the login information in subsequent communications between the client application and the payment system;
monitoring a port used by the client application for communications using the login information;
determining if a communication from the client application using the login information is directed to an authenticated server of the payment system; and
stopping the communication from the client application using the login information if the communication is directed to a non-authenticated server.

13. A method of building a database of reasonably verified voice prints in a payment system, the method comprising:
receiving a first payment request from a consumer requesting to transfer a valued asset from an account to a seller;
receiving from the consumer a first vocal authorization for the first payment request;
digitizing the first vocal authorization into a voice print;
storing the voice print in the database with the first payment request; and
completing the first payment request for the consumer and transferring the valued asset from the account to the seller.

14. The method of claim 13 further comprising:
segmenting the first vocal authorization into a statement of identity, a transaction number, and a date and a time; and
comparing the digitized statement of identity, the digitized transaction number and the digitized date and time with reference information for the transaction to determine if the statement of identity, the transaction number and the date and time spoken by the consumer are correct for the transaction.

15. The method of claim 13 further comprising creating a reliability rating for the voice print, wherein the reliability rating comprises a score representing a probability that the voice print is authentic for an account holder of the account and that the consumer is the account holder.

16. The method of claim 13 further comprising:
creating a reliability rating for the voice print, wherein the reliability rating comprises a score representing a probability that the voice print is authentic for an account holder of the account and that the consumer is the account holder; and
adjusting the reliability rating of the voice print if the account holder does not dispute the first payment request within a predetermined time.

17. The method of claim 13 further comprising:
creating a reliability rating for the voice print, wherein the reliability rating comprises a score representing a probability that the voice print is authentic for an account holder of the account and that the consumer is the account holder; and
adjusting the reliability rating of the voice print based on a number of payment requests completed by the account holder.

18. The method of claim 13 further comprising:
creating a reliability rating for the voice print, wherein the reliability rating comprises a score representing a probability that the voice print is authentic for an account holder of the account and that the consumer is the account holder; and
adjusting the reliability rating of the voice print based on a value of the first payment request.

19. The method of claim 13 further comprising:
creating a reliability rating for the voice print, wherein the reliability rating comprises a score representing a probability that the voice print is authentic for an account holder of the account and that the consumer is the account holder; and
adjusting the reliability rating of the voice print based on a time elapsed between a previous payment request and the first payment request.

20. The method of claim 13 further comprising:
creating a reliability rating for the voice print, wherein the reliability rating comprises a score representing a probability that the voice print is authentic for an account holder of the account and that the consumer is the account holder; and
raising a transaction limit for the consumer based on the reliability rating.

21. The method of claim 13 further comprising marking the voice print as authentic for an account holder of the account and determining that the consumer is the account holder if the account holder does not dispute the first payment request.

22. The method of claim 13 further comprising marking the voice print as not authentic for an account holder of the account and determining that the consumer is not the account holder if the account holder disputes the first payment request.

23. The method of claim 22 further comprising comparing a second vocal authorization for a second payment request with the not authentic voice print to determine if the second payment request is not authorized by the account holder.

24. The method of claim 13 further comprising:
receiving a second payment request from the consumer;
receiving from the consumer a second vocal authorization for the second payment request;
comparing the second vocal authorization with the voice print to determine if the
consumer is authorized to complete the second payment request; and
completing the second payment request.

25. The method of claim 13 wherein the comparing step further comprises:
receiving a calling phone number for the consumer speaking the first vocal authorization; and
comparing the calling phone number with a stored phone number for an account holder of the account to determine if the consumer is authorized to complete the first payment request.

26. The method of claim 13 wherein the receiving step further comprises:
receiving from the consumer a verbalization of a transaction number for the payment request;
converting the verbalization of the transaction number to a digital representation of the transaction number; and
comparing the digital representation of the transaction number with reference information for the transaction to determine if the digital representation of the transaction number is correct for the transaction to further determine if the consumer is authorized to complete the first payment request.

27. The method of claim 13 wherein the receiving step further comprises:
receiving from the consumer a verbalization of a date and a time for the payment request;
converting the verbalization of the date and the time to a digital representation of the date and the time; and
comparing the digital representation of the date and time with reference information for the transaction to determine if the digital representation of the date and the time is correct for the transaction to further determine if the consumer is authorized to complete the first payment request.

28. The method of claim 13 further comprising providing the voice print to the consumer for playback.

29. The method of claim 13 wherein the valued asset is a sovereign entity.

30. The method of claim 29 wherein the sovereign entity is gold.

31. The method of claim 13 wherein valued asset is currency credits, wherein each currency credit represents a denomination of currency.

32. The method of claim 13 further comprising:
requiring the consumer to download a plugin module to a client application;
allocating login information;
providing the login information to the client application;
using the login information in subsequent communications between the client application and the payment system;
monitoring a port used by the client application for communications using the login information;
determining if a communication from the client application using the login information is directed to an authenticated server of the payment system; and
stopping the communication from the client application using the login information if the communication is directed to a non-authenticated server.

33. A method for communicating with a payment system using a reverse firewall, the method comprising:
requiring the consumer to download a plugin module to a client application;
allocating login information;
providing the login information to the client application;
using the login information in subsequent communications between the client application and the payment system;
monitoring a port used by the client application for communications using the login information;
determining if a communication from the client application using the login information is directed to an authenticated server of the payment system; and
stopping the communication from the client application using the login information if the communication is directed to a non-authenticated server.

34. The method of claim 33 further comprising warning a user if an attempt is made by the client application to communicate with the non-authenticated server using the login information.

35. The method of claim 33 further comprising updating the plugin module to modify a list of authenticated servers of the payment system.

36. The method of claim 33 further comprising:
allocating new login information;
providing the new login information to the client application; and
updating the login information for the client application.

37. The method of claim 33 further comprising:
allowing a consumer to open a hyperlink in the client application, wherein the hyperlink is directed to a merchant server;
initiating a payment request from the merchant server to the payment system;
exchanging funds in the payment system between an account of the consumer and an account of the merchant server; and
exchanging an online asset between the client application and the merchant server.

38. A method for determining a credibility rating of a seller in a payment system, the method comprising:
receiving a payment request in the payment system from a consumer directed to the seller;
completing the payment request;
receiving a transaction rating from the consumer for the seller;
issuing an account rebate to the consumer in response to receiving the transaction rating; and
providing the transaction rating in a credibility rating of the seller.

39. The method of claim 38 further comprising querying the consumer for the transaction rating of the seller.

40. The method of claim 39 wherein the querying step further comprises querying the consumer for a numerical rating based on the transaction for at least one attribute of the seller.

41. The method of claim 38 further comprising determining a numerical score for the credibility rating of the seller based on a numerical rating for the seller received from a plurality of consumers.

42. The method of claim 38 further comprising adjusting a transaction fee for the seller based on the credibility rating.
